(19) United States
(12) Patent Application Publication
(10) Pub. No.: US 2012/0127179 A1
(43) Pub. Date: May 24, 2012

(54) METHOD, APPARATUS AND COMPUTER PROGRAM PRODUCT FOR USER INTERFACE

(75) Inventor: Richard Daniel Aspelin, Pargas (FI)

(73) Assignee: Nokia Corporation, Espoo (FI)

(21) Appl. No.: 12/950,775

(22) Filed: Nov. 19, 2010

(51) Int. Cl. G06F 3/041; G06T 11/20; G06F 3/00

(52) U.S. Cl. 345/441; 345/173; 715/700

(57) ABSTRACT

Provided herein are a method, apparatus and computer program product for conveying to a user of a mobile terminal the correct manner in which a finger should be located and moved to achieve a repeatable and reliable fingerprint scan. In particular, the method of example embodiments may include providing for display of a start mark proximate a fingerprint scanning sensor and receiving an indication of a touch at the start mark. The start mark may be displayed in a location relative to the fingerprint scanning sensor such that a swipe initiated at the start mark continues across the fingerprint scanning sensor. The method may further include providing for display of an instruction, where the instruction indicates a desired motion of a finger over the fingerprint scanning sensor. The method may also include changing at least one property of the start mark in response to receiving the indication of a touch at the start mark.

### TECHNOLOGICAL FIELD

Example embodiments of the present invention relate generally to the use of a fingerprint reader for verifying an authorized user, and more particularly, a method of providing a user an intuitive method of enrolling a fingerprint for future use in recognition and for proper use of the fingerprint reader.

### BACKGROUND

As nowadays different kinds of electronic devices can hold vast amounts of information, particularly personal information, it is important to safeguard these devices. Devices of this ilk may operate in at least two modes: a protected mode and an unprotected mode. In an unprotected mode, the device may allow access to some or all of the available services, applications, and functions of the device. In a protected mode, the device may prevent access to any or all services, applications, and functions of the device. To switch from an unprotected mode to a protected mode, various actions may be taken including a user may enter a key sequence to “lock” the device, the user may close the device (e.g., in the case of a flip phone or otherwise opening device), or the user may simply not enter an input for a predetermined amount of time. To switch from a protected mode to an unprotected mode, other predefined actions may be taken including a user may be required to enter a particular key sequence (e.g., a password or personal identification number (PIN)) or touch a touch-screen of the device in a particular manner (e.g., touching all four corners of a rectangular screen in a clockwise direction). Transitioning to the protected mode from the unprotected mode may allow a user of the device to have piece of mind that their personal information and the services on their device will not be used or accessed by an unauthorized user.

### SUMMARY

In general, an example embodiment of the present invention provides an improved technique of conveying to the user of a mobile terminal the correct manner in which a finger should be located and moved to achieve a repeatable and reliable fingerprint scan.

In particular, the method of example embodiments includes providing for display of a start mark proximate a fingerprint scanning sensor and receiving an indication of a touch at the start mark, where the start mark is displayed in a location relative to the fingerprint scanning sensor such that a swipe initiated at the start mark continues across the fingerprint scanning sensor. The method may further include providing for display of an instruction, wherein the instruction indicates a desired motion of a finger over the fingerprint scanning sensor. The method may also include changing at least one property of the start mark in response to receiving the indication of a touch at the start mark. The method may include activating a fingerprint input mode in response to receiving an indication of a touch at the start mark, where the fingerprint input mode may include a level of functionality that is different than the level of functionality active prior to activating the fingerprint input mode. Changing at least one property of the start mark in response to the indication of the touch at the start mark may include providing an indication of a correct touch pressure in response to receiving an indication of the correct touch pressure at the start mark. A property of the start mark, for example the shape, may guide a user to properly locate the touch. The method may further include providing for display of an indication that a touch has been received and receiving an indication that the fingerprint scanner has been reached. The method may still further include receiving a scanned fingerprint, associating the scanned fingerprint with a function, and performing the function in response to receiving the scanned fingerprint.

According to another embodiment of the present invention, an apparatus is provided. The apparatus may include at least one processor and at least one memory including computer program code. The at least one memory and the computer program code may be configured to, with the at least one processor, cause the apparatus to provide for display of a start mark proximate a fingerprint scanning sensor and receive an indication of a touch at the start mark, where the start mark is displayed in a location relative to the fingerprint scanning sensor such that a swipe initiated at the start mark continues across the fingerprint scanning sensor. The apparatus may further be caused to provide for display of an instruction, where the instruction indicates a desired motion of a finger over the fingerprint scanning sensor. The apparatus may also be caused to change at least one property of the start mark in response to receiving the indication of a touch at the start mark. The apparatus may further be caused to activate a fingerprint input mode in response to receiving the indication of a touch at the start mark, where the fingerprint input mode may include a level of functionality that is different than a level of functionality active prior to activating the fingerprint input mode. Causing the apparatus to change at least one property in response to the indication of a touch at the start mark may include causing the apparatus to provide an indication of a correct touch pressure in response to receiving an indication of the correct touch pressure at the start mark. A property of the start mark, for example the shape, may guide a user to properly locate the touch. The apparatus may further be caused to provide for display of an indication that a touch has been received and receive an indication that the fingerprint scanner has been reached. The apparatus may further be caused to receive a scanned fingerprint, associate the scanned fingerprint with a function, and perform the function in response to receiving the scanned fingerprint.

A further embodiment of the invention may include a computer program product including at least one computer-readable storage medium having computer-executable program code instructions stored therein. The computer executable program code instructions may include program code instructions for providing for display of a start mark proximate a fingerprint scanning sensor and program code instructions for receiving an indication of a touch at the start mark, where the start mark is displayed in a location relative to the fingerprint scanning sensor such that a swipe initiated at the start mark continues across the fingerprint scanning sensor. The computer program product may further include program code instructions for providing for display of an instruction, where the instruction indicates a desired motion of a finger over the fingerprint scanning sensor. The computer program product may further include program code instructions for changing at least one property of the start mark in response to receiving the indication of a touch at the start mark. The computer program product may also include program code instructions for activating a fingerprint input mode in response to receiving an indication of a touch at the start mark, wherein the fingerprint input mode includes a level of functionality that is different than a level of functionality active prior to activating the fingerprint input mode. The program code instructions for changing at least one property of the start mark in response to the indication of the touch at the start mark includes program code instructions for providing an indication of a correct touch pressure in response to receiving an indication of the correct touch pressure at the start mark. A property of the start mark, for example the shape, may guide a user to properly locate the touch. The computer program product may further include program code instructions for receiving a scanned fingerprint, program code instructions for associating the scanned fingerprint with a function, and program code instructions for performing the function in response to receiving the scanned fingerprint. The computer program product may further include program code instructions for providing for display of an indication that a touch has been received and program code instructions for receiving an indication that the fingerprint scanner has been reached.

According to still another example embodiment of the present invention, an apparatus is provided that includes means for providing for display of a start mark proximate a fingerprint scanning sensor and means for receiving an indication of a touch at the start mark, where the start mark is displayed in a location relative to the fingerprint scanning sensor such that a swipe initiated at the start mark continues across the fingerprint scanning sensor. The apparatus may further include means for providing for display of an instruction, wherein the instruction indicates a desired motion of a finger over the fingerprint scanning sensor. The apparatus may also include means for changing at least one property of the start mark in response to receiving the indication of a touch at the start mark. The apparatus may include means for activating a fingerprint input mode in response to receiving an indication of a touch at the start mark, where the fingerprint input mode may include a level of functionality that is different than the level of functionality active prior to activating the fingerprint input mode. The means for changing at least one property of the start mark in response to the indication of the touch at the start mark may include means for providing an indication of a correct touch pressure in response to receiving an indication of the correct touch pressure at the start mark. A property of the start mark, for example the shape, may guide a user to properly locate the touch. The start mark may be displayed in a location relative to the fingerprint scanning sensor such that a swipe initiated at the start mark continues across the fingerprint scanning sensor. The apparatus may further include means for receiving a scanned fingerprint, means for associating the scanned fingerprint with a function, and means for performing the function in response to receiving the scanned fingerprint. The apparatus may further still include means for providing for display of an indication that a touch has been received, and means for receiving an indication that the fingerprint scanner has been reached.

### BRIEF DESCRIPTION OF THE DRAWING(S)

Having thus described certain example embodiments of the invention in general terms, reference will now be made to the accompanying drawings, which are not necessarily drawn to scale, and wherein:

FIG. 1 illustrates an communication system in accordance with an example embodiment of the present invention;

FIG. 2 is a schematic block diagram of an apparatus according to an example embodiment of the present invention;

FIG. 3 is a schematic block diagram of a mobile device according to an example embodiment of the present invention;

FIG. 4 is an illustration of a mobile terminal performing operations in accordance with example embodiments of the present invention;

FIG. 5 is a flow chart of a method of operating an apparatus according to example embodiments of the present invention;

FIG. 6 is a flow chart of a method of operating a mobile terminal according to example embodiments of the present invention;

FIG. 7 is an illustration of a mobile terminal performing operations in accordance with further example embodiments of the present invention; and

FIG. 8 is a flow chart of a method of operating a mobile terminal according to another example embodiment of the present invention.

### DETAILED DESCRIPTION

Some example embodiments of the present invention will now be described more fully hereinafter with reference to the accompanying drawings, in which some, but not all embodiments of the invention are shown. Indeed, various embodiments of the invention may be embodied in many different forms and should not be construed as limited to the example embodiments set forth herein; rather, these example embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

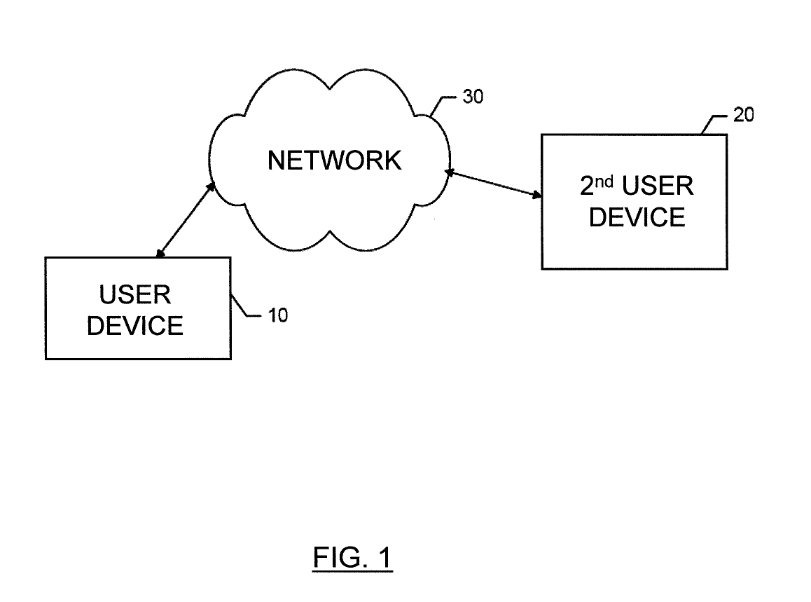

A session may be supported by a network 30 as shown in FIG. 1 that may include a collection of various different nodes, devices or functions that may be in communication with each other via corresponding wired and/or wireless interfaces or in ad-hoc networks such as those functioning over Bluetooth® interfaces. As such, FIG. 1 should be understood to be an example of a broad view of certain elements of a system that may incorporate example embodiments of the present invention and not an all inclusive or detailed view of the system or the network 30. Although not necessary, in some example embodiments, the network 30 may be capable of supporting communication in accordance with any one or more of a number of first-generation (1G), second-generation (2.G), 2.5G, third-generation (3G), 3.5G, 3.9G, fourth-generation (4G) mobile communication protocols and/or the like.

One or more communication terminals, such as the mobile terminal 10 and the second mobile terminal 20, may be in communication with each other via the network 30 and each may include an antenna or antennas for transmitting signals to and for receiving signals from a base site, which could be, for example a base station that is part of one or more cellular or mobile networks or an access point that may be coupled to a data network, such as a local area network (LAN), a metropolitan area network (MAN), and/or a wide area network (WAN), such as the Internet. In turn, other devices (e.g., personal computers, server computers or the like) may be coupled to the mobile terminal 10 and the second mobile terminal 20 via the network 30. By directly or indirectly connecting the mobile terminal 10 and the second mobile terminal 20 and other devices to the network 30, the mobile terminal 10 and the second mobile terminal 20 may be enabled to communicate with the other devices or each other, for example, according to numerous communication protocols including Hypertext Transfer Protocol (HTTP) and/or the like, to thereby carry out various communication or other functions of the mobile terminal 10 and the second mobile terminal 20, respectively.

In example embodiments, either of the mobile terminals may be mobile or fixed communication devices. Thus, for example, the mobile terminal 10 and the second mobile terminal 20 could be, or be substituted by, any of personal computers (PCs), personal digital assistants (PDAs), wireless telephones, desktop computer, laptop computer, mobile computers, cameras, video recorders, audio/video players, positioning devices, game devices, television devices, radio devices, or various other devices or combinations thereof. Further, example embodiments of the present invention may not require network access as some embodiments may operate in the absence of network communication. Such embodiments may include apparatuses that do not employ network connectivity hardware or the apparatuses may be configured to not access a network, such as a mobile terminal in an “airplane mode” in which all wireless connectivity is deactivated.

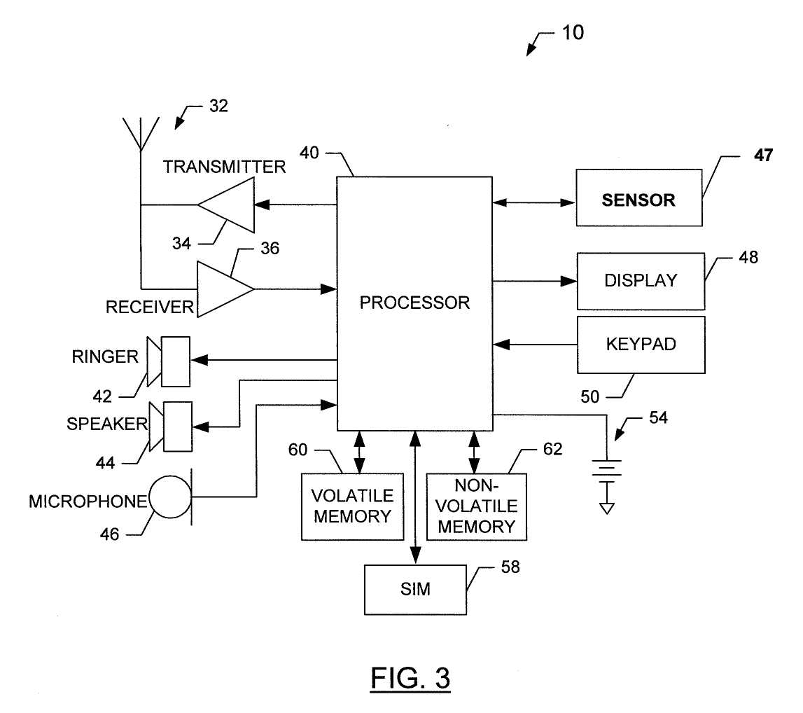

Although the mobile terminal 10 may be configured in various manners, one example of a mobile terminal that could benefit from an example embodiment of the invention is depicted in the block diagram of FIG. 3. While several embodiments of the mobile terminal may be illustrated and hereinafter described for purposes of example, other types of mobile terminals, such as personal digital assistants (PDAs), pagers, mobile televisions, gaming devices, all types of computers (e.g., laptops or mobile computers), cameras, audio/video players, radios, global positioning system (GPS) devices, or any combination of the aforementioned, and other types of communication devices, may employ an example embodiment of the present invention. As described, the mobile terminal may include various means for performing one or more functions in accordance with an example embodiment of the present invention, including those more particularly shown and described herein. It should be understood, however, that a mobile terminal may include alternative means for performing one or more like functions, without departing from the spirit and scope of the present invention.

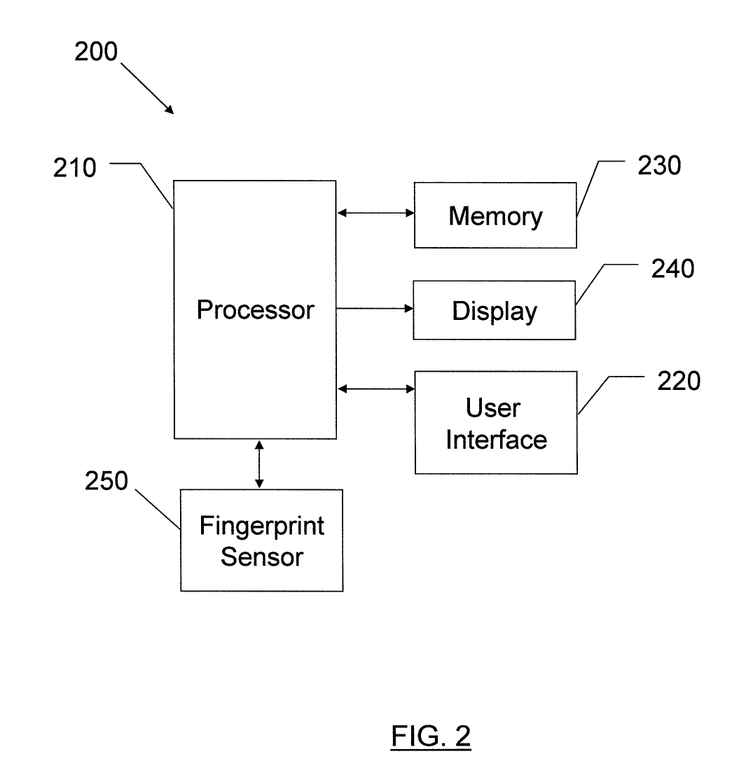

An example embodiment of an apparatus that may provide for initiating a swipe on a touch screen and continuing the swipe to a fingerprint sensor is provided in FIG. 2. The apparatus may include or otherwise be in communication with a processor 210, a user interface 220, and a memory device 230. While the user interface 220 and the display 240 are depicted individually, the user interface 220 and the display 240 may be embodied as a single touch screen which serves as both a user interface 220 and a display 240. Further a touch screen user interface and display may be employed with additional user interface components, for example buttons, sensors, or fingerprint readers among others. An additional sensor, such as fingerprint sensor 250 may be included in communication with processor 210. In some embodiments, the processor 210 (and/or co-processors or any other circuitry assisting or otherwise associated with the processor 210) may be in communication with the memory device 230 via a bus for passing information among components of the apparatus 200. The memory device 230 may include, for example, one or more volatile and/or non-volatile memories. In other words, for example, the memory device 230 may be an electronic storage device (e.g., a computer readable storage medium) comprising gates configured to store data (e.g., bits) that may be retrievable by a machine (e.g., a computing device like the processor 210). The memory device 230 may be configured to store information, data, applications, instructions or the like for enabling the apparatus to carry out various functions in accordance with example embodiments of the present invention. For example, the memory device 230 could be configured to buffer input data for processing by the processor 210. Additionally or alternatively, the memory device 230 could be configured to store instructions for execution by the processor 210.

The apparatus 200 may, in some embodiments, be a mobile terminal, as depicted in FIG. 3, or a fixed communication device or computing device configured to employ an example embodiment of the present invention. However, in some embodiments, the apparatus 200 may be embodied as a chip or a chip set. Embodiments of the apparatus may not necessarily include the user interface 220 or the fingerprint sensor 250, but the apparatus may be configured to receive and/or provide information to and/or from the user interface and the fingerprint sensor. In other words, the apparatus 200 may comprise one or more physical packages (e.g., chips) including materials, components, and/or wires on a structural assembly (e.g., a baseboard). The structural assembly may provide physical strength, conservation of size, and/or limitation of electrical interaction for component circuitry included thereon. The apparatus 200 may therefore, in some cases, be configured to implement embodiments of the present invention on a single chip or as a single “system on a chip.” As such, in some cases, a chip or chip set may constitute means for performing one or more operations for providing the functionalities described herein.

Referring again to the example embodiment of FIG. 3 including a mobile terminal 10, the apparatus may include an antenna 32 (or multiple antennas) in operable communication with a transmitter 34 and a receiver 36. The mobile terminal may further include an apparatus, such as a processor 40, that provides signals to and receives signals from the transmitter and receiver, respectively. The signals may include signaling information in accordance with the air interface standard of the applicable cellular system, and/or may also include data corresponding to user speech, received data and/or user generated data. In this regard, the mobile terminal may be capable of operating with one or more air interface standards, communication protocols, modulation types, and access types. By way of illustration, the mobile terminal may be capable of operating in accordance with any of a number of first, second, third and/or fourth-generation communication protocols or the like. For example, the mobile terminal may be capable of operating in accordance with second-generation (2G) wireless communication protocols IS-136, GSM (Global System for Mobile communications) and IS-95, or with third-generation (3G) wireless communication protocols, such as UMTS (Universal Mobile Telecommunications System), CDMA2000 (Code Division Multiple Access), wideband CDMA (WCDMA) and time division-synchronous CDMA (TD-SCDMA), with 3.9G wireless communication protocols such as E-UTRAN (evolved—UMTS (Universal Mobile Telecommunications System) terrestrial radio access network), with fourth-generation (4G) wireless communication protocols or the like.

It is understood that the apparatus, such as the processor 40, may include circuitry implementing, among others, audio and logic functions of the mobile terminal 10. The processor of example embodiments 40, 210 may be embodied in a number of different ways. For example, the processor 40, 210 may be embodied as one or more of various processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 40, 210 may include one or more processing cores configured to perform independently. A multi-core processor may enable multiprocessing within a single physical package. Additionally or alternatively, the processor 40 may include one or more processors configured in tandem via the bus to enable independent execution of instructions, pipelining and/or multithreading.

In an example embodiment with reference to FIG. 3, the processor 40 may be configured to execute instructions stored in the memory device 62 or otherwise accessible to the processor 40. Alternatively or additionally, the processor 40 may be configured to execute hard coded functionality. As such, whether configured by hardware or software methods, or by a combination thereof, the processor 40 may represent an entity (e.g., physically embodied in circuitry) capable of performing operations according to embodiments of the present invention while configured accordingly. Thus, for example, when the processor 40 is embodied as an ASIC, FPGA or the like, the processor 40 may be specifically configured hardware for conducting the operations described herein. Alternatively, as another example, when the processor 40 is embodied as an executor of software instructions, the instructions may specifically configure the processor 40 to perform the algorithms and/or operations described herein when the instructions are executed. However, in some cases, the processor 40 may be a processor of a specific device (e.g., a mobile terminal or network device) adapted for employing embodiments of the present invention by further configuration of the processor 40 by instructions for performing the algorithms and/or operations described herein. The processor 40 may include, among other things, a clock, an arithmetic logic unit (ALU) and logic gates configured to support operation of the processor 40.

The mobile terminal 10 may also comprise a user interface including an output device such as an earphone or speaker 44, a ringer 42, a microphone 46, a display 48, and a user input interface, which may be coupled to the processor 40. The mobile terminal 10 may further include sensor(s) 47 for detecting a stimulus such as a button for detecting a depression, a touch sensitive display for detecting a touch, or a motion sensor to detect motion. The sensor 47 may also include a fingerprint scanning sensor. The user input interface, which allows the mobile terminal to receive data, may include any of a number of devices allowing the mobile terminal to receive data, such as a keypad 50, a touch sensitive display (not shown) or other input device. In embodiments including the keypad, the keypad may include numeric (0-9) and related keys (#, *), and other hard and soft keys used for operating the mobile terminal 10. Alternatively, the keypad may include a conventional QWERTY keypad arrangement. The keypad may also include various soft keys with associated functions. In addition, or alternatively, the mobile terminal may include an interface device such as a joystick or other user input interface. The mobile terminal may further include a battery 54, such as a vibrating battery pack, for powering various circuits that are used to operate the mobile terminal, as well as optionally providing mechanical vibration as a detectable output.

The mobile terminal 10 may further include a user identity module (UIM) 58, which may generically be referred to as a smart card. The UIM may be a memory device having a processor built in. The UIM may include, for example, a subscriber identity module (SIM), a universal integrated circuit card (UICC), a universal subscriber identity module (USIM), a removable user identity module (R-UIM), or any other smart card. The UIM may store information elements related to a mobile subscriber. In addition to the UIM, the mobile terminal may be equipped with memory. For example, the mobile terminal may include volatile memory 60, such as volatile Random Access Memory (RAM) including a cache area for the temporary storage of data. The mobile terminal may also include other non-volatile memory 62, which may be embedded and/or may be removable. The non-volatile memory may additionally or alternatively comprise an electrically erasable programmable read only memory (EEPROM), flash memory or the like. The memories may store any of a number of pieces of information, and data, used by the mobile terminal to implement the functions of the mobile terminal. For example, the memories may include an identifier, such as an international mobile equipment identification (IMEI) code, capable of uniquely identifying the mobile terminal. Furthermore, the memories may store instructions for determining cell id information. Specifically, the memories may store an application program for execution by the processor 40, which determines an identity of the current cell, e.g., cell id identity or cell id information, with which the mobile terminal is in communication.

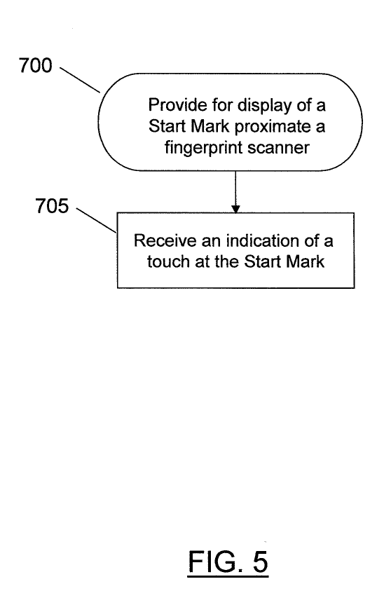

An example embodiment of a communication network in accordance with one example embodiment is presented by FIG. 1. Flowcharts illustrating operations performed by an example embodiment are presented in the flowcharts of FIGS. 5, 6, and 8 It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of an apparatus employing an embodiment of the present invention and executed by a processor in the apparatus. As will be appreciated, any such computer program instructions may be loaded onto a computer or other programmable apparatus (e.g., hardware) to produce a machine, such that the resulting computer or other programmable apparatus embody means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s).

Accordingly, blocks of the flowcharts support combinations of means for performing the specified functions, and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In an example embodiment, an apparatus for performing the methods of FIGS. 5, 6, and 8, described further below, may comprise a processor (e.g., the processor 40) configured to perform some or each of the operations (700-705, 400-470, or 600-680) described below. The processor may, for example, be configured to perform the operations (700-705, 400-470, or 600-680) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 700-705, 400-470, or 600-680 may comprise, for example, the processor 40 and/or a device or circuit for executing instructions or executing an algorithm for processing information as described further below.

Mobile terminals, such as mobile terminal 10 of FIG. 3 may be configured to operate in at least first mode and a second mode. The first mode may be an unprotected mode whereby a user of the mobile terminal may have access to the information stored on the mobile terminal (e.g., in memories 60, 62), the user may have access to applications on the mobile terminal, and the user may have access to services that the mobile terminal can access (e.g., internet, voice calls, SMS (short messaging service) text messages, etc.). The second mode may be a protected mode wherein a user is precluded from accessing at least one of information, applications, or services. The protected mode may be any mode in which access to at least one function is inhibited; however, the protected mode may preclude any function of the mobile terminal from being accessed. The protected mode, as referenced herein, may also preclude use of, only a subset of services or applications, such as only a single service or application. For example, if a mobile terminal is on a service plan that charges for internet usage, the protected mode may preclude the internet from being accessed without first “unlocking” the mobile terminal (e.g., entering the unprotected mode). Thus, the protected mode as discussed herein may reference any embodiment in which a user is required to provide a password, key sequence, or other operation authenticating the request for access.

Unlocking (e.g., transitioning from a protected mode to an unprotected mode) can be performed through a number of different methods. Passwords, passcodes, and key sequences are possible methods of unlocking a device such as a mobile terminal. Additional methods include drawing a figure or pattern on a touch screen input, a long-depression of a particular key, among others. Each of these aforementioned methods can be entered by any individual such that a person need only observe an authorized user entering the unlocking information in order to replicate the unlocking information or guess the unlocking information and access the unprotected mode.

Identity-based unlocking methods may be used to improve security and preclude an unauthorized user from simply entering the required unlocking information. Identity-based unlocking may include retinal scanning, facial scanning, and fingerprint scanning. Each of these methods requires that an appropriate user perform the unlocking procedure. While retinal and facial scanning may require appropriate lighting and cameras, fingerprint scanning can be performed using optical or capacitance scanning in environments that are not conducive to facial or retinal scanning. Further, at least in some environments, fingerprint scanning tends to be reliable and relatively inexpensive to implement. Identity-based unlocking techniques can be performed exclusive of, or in addition to password-based unlocking techniques.

In fingerprint scanning, both optical scanning using photo diodes and capacitance scanning using conductor plates create an image of a fingerprint. The image created is used for comparison to known fingerprints through the use of algorithms which recognize and analyze the unique features of each fingerprint. In order to accurately compare a scanned fingerprint with known fingerprints, the scanned fingerprint (and the originally registered fingerprint) usually needs to be scanned in a consistent and repeatable fashion. Some fingerprint scanners include a narrow band of photo diodes or conductor plates such that the scanner is compact. Such scanners usually require a fingerprint to be “swiped” across the band of sensors for the scanner to create an image of the entire fingerprint. “Swiping,” as referred to generally herein, may include dragging a fingerprint across the sensor, a continuous movement of the fingerprint across the sensor, or a touch gesture toward or in contact with the sensor among other possible movements. The pressure with which a finger is pressed against a scanner together with the direction that the finger is swiped are factors that may influence the quality of the fingerprint scanned. As such, it is important that a user of a fingerprint scanner is aware of how to repeatably scan their fingerprints.

Embodiments of the present invention may be included on any variety of devices. While example embodiments are described primarily with respect to a mobile terminal, further example embodiments may be employed by any device that may benefit from determining the identity of an individual based upon a scanned fingerprint. Such embodiments may include a security system adapted to lock and unlock a door, systems adapted to lock and unlock a desktop computer, apparatuses adapted to use a fingerprint as a digital signature to approve a document, apparatuses adapted to identify an individual for a sign-in procedure or roll-call, etc. Example embodiments of the present invention may provide a method of user identity such that the invention may be embodied on any number of apparatuses that are used for determining the identity of a user.

Mobile terminals, such as mobile terminal 10 of the example of FIG. 3 may include a fingerprint scanning sensor 47 that may be configured for, for example, optical or capacitance scanning. The fingerprint scanner may be implemented, for example, on a body of a device or it may be incorporated as part of a touch screen. The fingerprint scanner may be of the type described above in which a narrow band of photodiodes or conductor plates are used in order to have a more compact fingerprint scanner. The fingerprint scanner may read a fingerprint and compare the read fingerprint to known fingerprints that are stored, for example, in memory 62. An authorized user of a mobile terminal may set up security levels and protections for access to various functions, applications, and services on the mobile terminal. These protections may include options of using password protection and/or fingerprint protection of the various functions, applications, and services. Different protective measures may be used for different functions and they may include one or both of password and fingerprint protection. Additionally, fingerprints may be used for launching applications or as shortcuts to functions of a mobile terminal. As each fingerprint for each finger is unique, a user may conceivably create ten shortcuts that are each available when the user swipes a corresponding finger. Multiplexing of fingerprints with other fingerprints or with other keystrokes or mobile terminal operating modes may allow considerably more than ten functions to be associated with a user's fingerprints. While fingerprint registration is described herein with regard to using the fingerprint for an unlocking mechanism, the same registration process and swiping of fingerprints may similarly be used for creating and executing shortcuts.

To establish a fingerprint based unlocking process, a fingerprint is first registered as the known identity to serve as a reference fingerprint. In example embodiments of the present invention, the display 48 of the mobile terminal 10 may present instructions to a user regarding the establishment of a reference fingerprint for an authorized user. The instructions may be accessed through a set-up menu that enables a user to create the fingerprint protection for the functions, applications, or services desired.

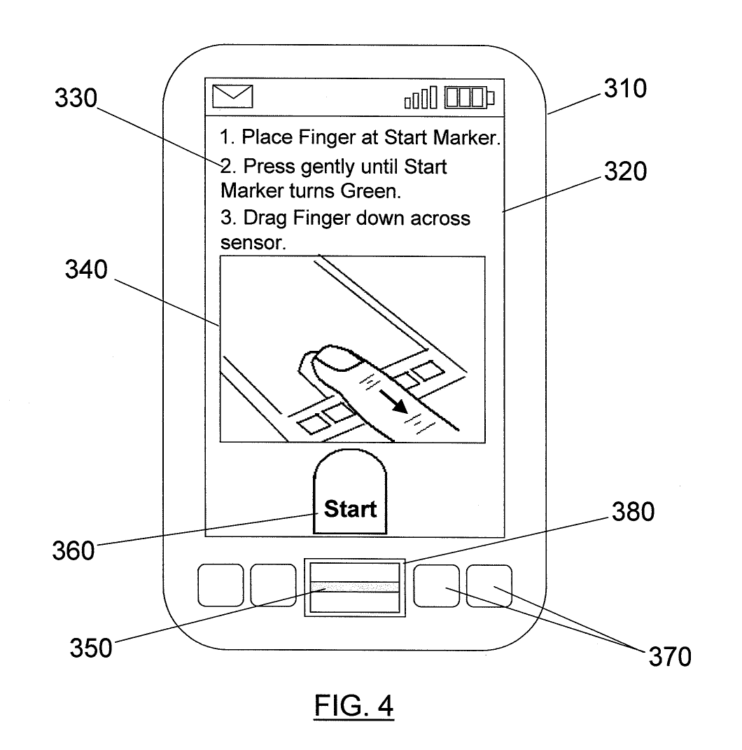

FIG. 4 depicts an example embodiment of a user interface, typically driven by a processor, to provide instructions to a user for properly scanning a fingerprint. The instructions may be provided during a set-up procedure in which a user is creating the reference fingerprints that are used for authorizing or authenticating the user. The instructions may also be provided if the mobile terminal determines that the user is using an improper technique for attempting to scan a fingerprint.

The mobile terminal 310 of FIG. 4 may be configured with a touch screen 320 that can be used as an input for the mobile terminal 310. The mobile terminal 310 may be further configured with additional inputs, such as buttons 370. The instructions provided may include text 330 that provides steps for properly scanning a fingerprint. The instructions may also include a picture or graphic 340 that depicts how a user is to properly scan a fingerprint. The mobile terminal may further include a fingerprint scanner 350 as shown. The fingerprint scanner may be configured to receive information on a drag of a finger across the fingerprint scanner 350 in order to obtain a useable fingerprint image. The instructions 330 may direct a user to place their finger on a start mark 360 or particular area of the display located proximate the fingerprint scanner 350 (e.g., such that when a user's finger tip is placed on the start mark 360, the rest of the finger extends to or over the fingerprint scanner 350). The start mark 360 may be disposed in any direction from the fingerprint scanner 350, for example, to the left, right, above, or below the finger print scanner 350 such that the direction that the finger is swiped is determined relative to the relationship between the start mark 360 and the fingerprint scanner 350. The start mark 360 may be configured such that when a user places their finger at the start mark 360, the natural tendency or natural motion of the user is to drag or swipe their finger across the fingerprint scanning 350. A property of the start mark, such as the shape or surrounding display as will be further described below, may guide a user to properly locate a touch of the start mark 360. Further, the start mark 360 may be shaped in a manner that resembles the shape of the touch expected. For example, in the example embodiment of FIG. 4, the start mark 360 is of a shape that resembles a finger tip thereby encouraging a user to place their fingertip in the correct location on the display 320. The start mark may be of a first color, such as red, before it is touched by a user. In the illustrated embodiment, the touch screen display 320 is configured to be able to determine an amount of pressure applied by a user touching the touch screen 320. When the user places their finger on the start mark 360, the touch screen 320 determines if the pressure sensed is appropriate for achieving a usable fingerprint scan. If the pressure is too light or too heavy, the sensor 350 may not detect a usable fingerprint image. When the touch screen 320 determines that the correct amount of pressure is being applied, the start mark 360 may turn a second color (e.g., green) indicating that the second step has been properly completed. Example embodiments may include a graphical interface that indicates the appropriate touch pressure to a user through, for example, a scale in which a user is directed to keep an indicator, such as an icon or pointer, within an acceptable pressure range on a dial or linear scale. Such embodiments with a graphical interface may also use colors to indicate whether the pressure is too light or too heavy by a color scale with, for example red on one end of the scale (e.g., too heavy), blue on the other (e.g., too light), and green disposed in the middle wherein the pressure is correct. This indication may use the start mark 360 itself to display the appropriate touch pressure. The pressure indication is not necessary and other embodiments may not include a touch screen 320 that can detect pressure such that the start mark 360 may turn a second color upon receiving an indication of a touch at the start mark 360. Once the start mark 360 has turned the second color, the finger may be dragged down, across the sensor 350. The instructions shown in FIG. 4 may be displayed altogether initially or they may be incrementally added as the user completes each step of the instructions. For example, step two instructing the user to press gently until the start mark turns green may not appear until the user has completed step one of placing a finger at the start mark. While the display of different colors was described above, other techniques for providing feedback or cues to the user may be employed, either alternatively or additionally.

While the example embodiment of FIG. 4 depicts text instructions 330 accompanying a graphic instruction 340 for properly swiping a finger across the fingerprint scanner 350, such instructions may not be required. For example, upon using the fingerprint scanner once or multiple times, a user may become familiar with the proper technique such that the instructions aren't necessary. The instructions may also not be required in cases where instructions are provided elsewhere, such as an instruction manual, or when the fingerprint scanning process is deemed intuitive to the intended user of the device. In such example embodiments, the displayed information relevant to the fingerprint scanning may include only a start mark 360. In such an embodiment the information presented on the display 320 prior to the fingerprint scanning process may only be minimally obscured, if at all, by a relatively small start mark 360. A further enhancement to example embodiments may include an illumination near the fingerprint scanner 350 indicating it is anticipating a fingerprint swipe. Such illumination may include illumination of a perimeter of the fingerprint scanner 350, for example, 380, or any other potential illumination that may draw attention to the fingerprint scanner 350, such as dimming all other device illumination while illuminating an area near the fingerprint scanner.

In an example embodiment of the present invention, upon detection of a touch at the start mark 360, the mobile terminal 310 may disable some or all other functions or inputs (e.g., buttons 370, other inputs that were previously available on the touch screen 320, etc.) by entering into a fingerprint reading mode, until the fingerprint has been scanned at the fingerprint scanner 350. For example, when a user initiates a fingerprint scan by placing their finger at the start mark 360, the fingerprint reading mode may be activated such that any other items that are displayed (e.g., applications, other inputs, etc.) may be deactivated such that a touch received on, for example, an icon typically used to launch an application, is ignored by the mobile terminal 310. This fingerprint reading mode may include a level of functionality that is different than the level of functionality that is available before or after the fingerprint reading mode has been entered. The level of functionality may include operational states for the number of inputs available to a user, the functions available (e.g., phone calls, music playback, e-mail, etc.) such that a change in the level of functionality affects the user's ability to interface with various aspects of the apparatus. Functionality may be restored to the original level of functionality, or a different level of functionality, in response to determining that the finger print had been scanned, or at least determining that the fingerprint swipe had been started by detecting the movement of the fingerprint toward the fingerprint scanner 350.

Example embodiments of the present invention may further include an arrangement of the start mark 360 and the fingerprint scanner 350 in such a configuration that upon the user touching the start mark 360, the finger is in a position where swiping the fingerprint across the scanner is intuitive or second nature. Such a configuration may include a start mark 360 that is located in such a close relationship with the fingerprint scanner 350 that upon a user touching the start mark 360, the fingerprint is at least partially disposed on the fingerprint scanner 350 simultaneously. In this regard, at least a portion of the fingerprint may be scanned upon the user touching the start mark 360.

Another method of providing instructions to a user regarding how to properly have their fingerprints scanned may include a “fingerprint reader wizard” which may be an application that may be stored by memory and executed by a mobile terminal, such as the processor of the mobile terminal, according to example embodiments of the present invention. Such a “fingerprint reader wizard” may be started by an authorized user and the application may guide a user through the steps of registering a fingerprint. The wizard may show a tutorial video or pictographic instruction. The user may then be led through the steps of registering a fingerprint to be used subsequently for authenticating that user.

The example of FIG. 5 depicts a flowchart of a method of initiating a fingerprint scan. The process begins at 700 in which a start mark is displayed proximate a fingerprint scanning sensor. The start mark may be displayed, for example, on display 240 of FIG. 2 where the display 240 may also be a touch screen. At 705, the indication of a touch at the start mark may be received. Optionally, if an indication of a touch is not received within a predetermined period of time, the process for initiating a fingerprint scan may end and the device on which the example embodiment is implemented may revert to the function active prior to the initiating of a fingerprint scan.

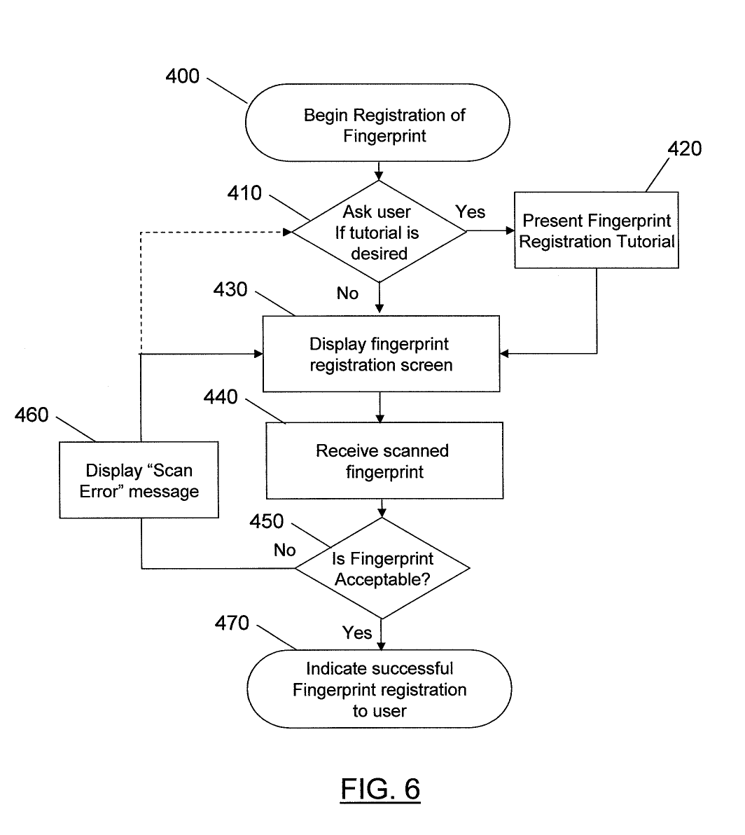

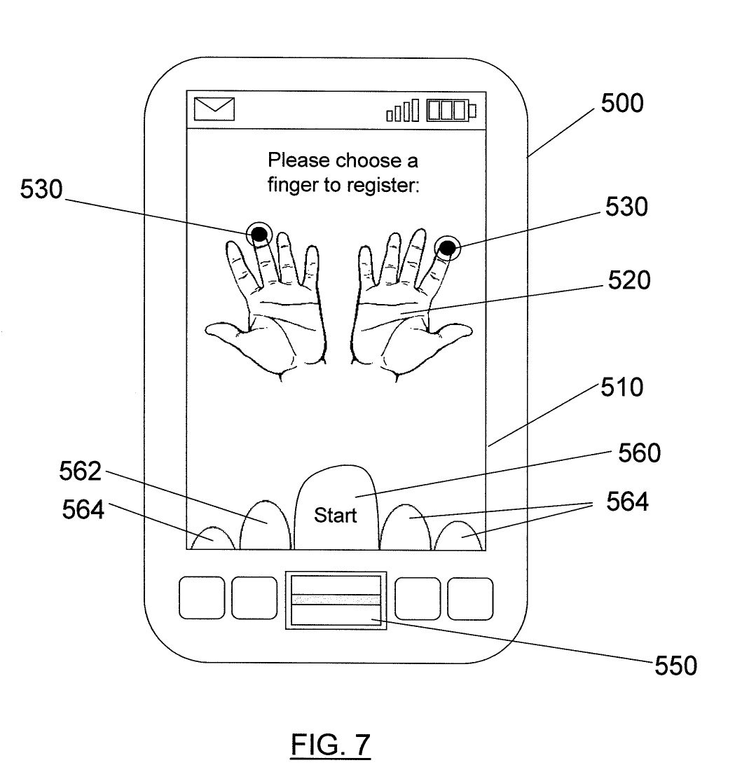

The example of FIG. 6 depicts a flowchart of a method of registering a fingerprint for use in later authenticating a user. The process begins at 400 with the user indicating that they wish to register a fingerprint for security or application shortcut purposes, such as by selecting the corresponding option from a menu. At 410 the user is asked whether or not they would like to view a tutorial on registration of a fingerprint. For example, the processor may cause the touch screen to display a question to the user relating to their desire for a tutorial. This tutorial may be useful for a user who has not previously registered a fingerprint or who has not done so for a long period of time. If the tutorial is requested, the processor may cause the processor to be displayed, such as upon the touch screen, at 420. The tutorial may be a step-by-step instruction or a video instructing a user how to register a fingerprint. After the tutorial, or if the tutorial is not requested, the finger registration screen is presented at 430. For example, the processor may cause the touch screen to display the finger registration screen. An example of a finger registration screen is illustrated in the example of FIG. 7 as will be discussed further below. The user then swipes a finger across the sensor and a scanned fingerprint is received by the fingerprint sensor and, in turn the processor, at 440. The mobile terminal may emit a tone or a vibratory response, such as a result of the processor driving the appropriate output device, to indicate that a fingerprint was successfully scanned. The mobile terminal, for example using the processor, may determine whether or not the fingerprint is acceptable at 450. If the fingerprint is too light, too dark, falls below a certain confidence level (e.g., not enough fingerprint features visible on the scanned image), or otherwise fails to satisfy predefined criteria, then an error message is displayed at 460 and the fingerprint registration screen is once again displayed at 430, such as a processor causing the touch screen to provide the appropriate display. If the fingerprint is read several times (e.g., 4 attempts) and the processor determines that it is unacceptable each time, the user may be asked again if the tutorial is desired at 410 to ensure that the fingerprint is being scanned properly. Once the processor determines that the fingerprint is acceptable at 450, a successful fingerprint registration may be indicated to the user at 470. Some embodiments may require a fingerprint to be scanned multiple times in order to verify that the fingerprint scanned is repeatable and contains enough unique information to be a secure and reliable fingerprint. In such instances, when an acceptable fingerprint is received as determined at 450, another fingerprint scan may be requested together with a number of acceptable scans that are required for complete registration of the fingerprint.

FIG. 7 illustrates an example embodiment of a fingerprint registration screen that may be caused by the processor to be displayed on the display 48 of a mobile terminal (e.g., mobile terminal 10). The embodiment of FIG. 7 may include a mobile terminal 500 with a touch screen 510. The display may present to a user a choice of which finger on which hand to register. The illustrated embodiment displays a left and right hand 520 from which a user selects a finger. The hands 520 may include indicators 530 which indicate which fingers have previously been registered. Different fingers may be used for different purposes such as for different levels of security or possibly for launching different applications or as shortcuts to functions of a mobile terminal. Such a shortcut may include a speed-dial that is assigned to a particular finger among many possible embodiments. The fingerprint registration screen may include a start mark 560 proximate the fingerprint sensor 550 for use as described above with regard to FIG. 4. The start mark 560 may be touch sensitive such that it is a first color to indicate that a user is to touch the start mark 560 and it may turn a second color upon receiving an indication of the touch of a user. As noted with respect to the example embodiment of FIG. 4, the start mark 560 may be of a shape that is indicative of the type and direction of touch that is desirable for a proper fingerprint scan. A property of the start mark, such as the shape, may guide a user to properly locate the touch of the start mark. As unique fingerprints exist on each phalange of each digit of a hand, the fingerprints of different phalanges may be used for different functions. To that end, the type of touch may include the phalange that is requested (e.g., an index finger fingertip). The type of touch may further be depicted by the shape of the start mark 560 or indicated by a graphic (e.g., hands 520 with phalange indicators 530) and optionally a graphic depiction of additional fingers may be adjacent to the start mark 560. For example, if a graphic illustration of one finger 562 and a thumb 564 is displayed to the left of start mark 560 and a graphic illustration of two fingers 566 are indicated to the right of start mark 560, the fingerprint anticipated by the device 500 may be the fingertip of the middle finger. The touch screen 510 may also be configured to receive an indication of the shape of the area touched in an effort to determine if the user has placed their finger in the appropriate position to commence a swipe. The user may then swipe their finger down across the fingerprint sensor 550 to scan the fingerprint. Once a fingerprint is registered, it may be used for unlocking the mobile terminal 510 or executing any number of functions assigned by a user. Assigning such functions may be performed in the same manner in which shortcut keys are assigned to various functions of a mobile terminal.

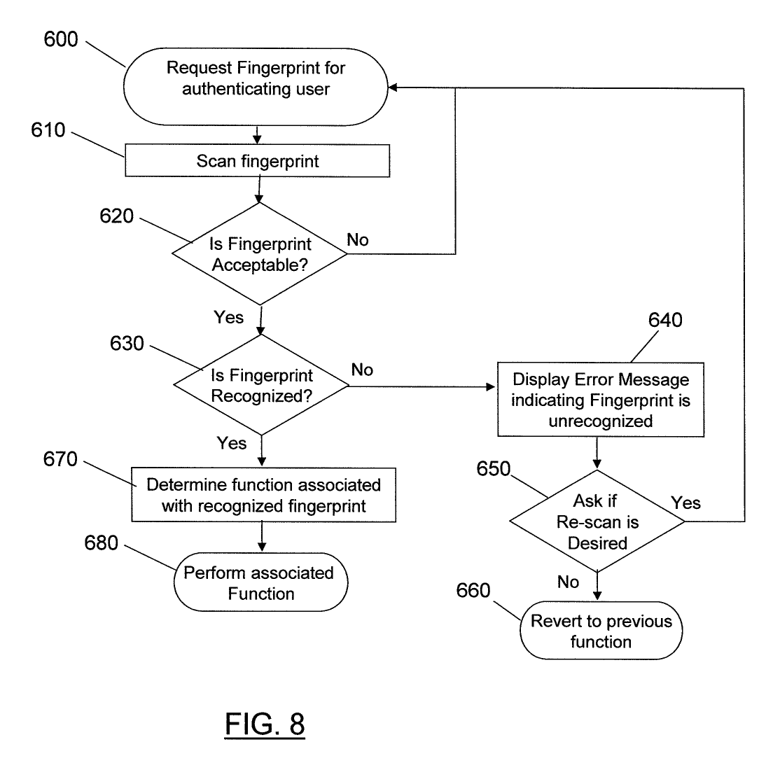

FIG. 8 depicts a flowchart illustrating a process according to example embodiments of the invention. A user of a mobile terminal, such as mobile terminal 10, may indicate that they wish to unlock a device or use a function that requires user authentication via a fingerprint. The mobile terminal, such as the processor of the mobile terminal, may provide for display, for example on a touch screen, of a request for fingerprint authentication at 600. The fingerprint may be scanned by the fingerprint sensor at 610 by a user dragging their finger across the fingerprint sensor. At operation 620, a determination may be made by the mobile terminal or processor thereof, as to whether or not the fingerprint is acceptable. An acceptable fingerprint may include an image with sufficient detail for the fingerprint recognition algorithms to determine if the fingerprint is a match with a registered fingerprint, at least to within a predefined confidence level. If the fingerprint scanned is not acceptable (e.g., due to low pressure on sensor, incorrect swipe angle, swipe was too fast, etc.), the fingerprint scan may be requested again at 600. The request may be presented, for example, by the touch screen display. If the fingerprint is acceptable, the mobile terminal (e.g., the processor) may compare the fingerprint to the fingerprints stored in a memory using fingerprint recognition algorithms at 630. If the fingerprint is not recognized at 630 (e.g., there is no match as determined by the processor when the fingerprint is compared with those in the memory), an error message may be presented on the display at 640 and a request for a re-scan of the fingerprint may be offered by presentation of the request on the display at 650. If the rescan is desired, the request for the fingerprint is presented on the display at 600. If a rescan is not desired, for example if the user realizes that they are not an authorized user or that their fingerprint has not been properly registered, then the mobile terminal may revert to the functionality that was enabled before the request for fingerprint authentication (e.g., after the fingerprint scan is canceled by a user or after an elapsed period of time), which may include a locked mode. If the fingerprint is recognized (e.g., through a comparison with fingerprints stored in the memory by the processor using the algorithms) at 630, the mobile terminal, or the processor thereof, may determine the function associated with the recognized fingerprint (e.g., speed-dial, unlock, etc.) at 670 and the mobile terminal may perform the associated function at 680.

As described above and as will be appreciated by one skilled in the art, embodiments of the present invention may be configured as a system, method or electronic device. Accordingly, embodiments of the present invention may be comprised of various means including entirely of hardware or any combination of software and hardware. Furthermore, embodiments of the present invention may take the form of a computer program product on a computer-readable storage medium having computer-readable program instructions (e.g., computer software) embodied in the tangible, non-transitory storage medium. Any suitable computer-readable storage medium may be utilized including hard disks, CD-ROMs, optical storage devices, or magnetic storage devices.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and associated drawings describe example embodiments in the context of certain example combinations of elements and/or functions, it should be appreciated that different combinations of elements and/or functions may be provided by alternative embodiments without departing from the spirit and scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
providing for display of a start mark proximate a fingerprint scanning sensor; and
receiving an indication of a touch at the start mark;
wherein the start mark is displayed in a location relative to the fingerprint scanning sensor such that a swipe initiated at the start mark continues across the fingerprint scanning sensor.

2. The method according to claim 1, further comprising providing for display of an instruction, wherein the instruction indicates a desired motion of a finger over the fingerprint scanning sensor.

3. The method according to claim 1, further comprising changing at least one property of the start mark in response to receiving the indication of a touch at the start mark.

4. The method according to claim 1, further comprising activating a fingerprint input mode in response to response to receiving the indication of a touch at the start mark, wherein the fingerprint input mode includes a level of functionality that is different than a level of functionality active prior to activating the fingerprint input mode.

5. The method according to claim 3, wherein changing at least one property of the start mark in response to the indication of the touch at the start mark includes providing an indication of a correct touch pressure in response to receiving an indication of the correct touch pressure at the start mark.

6. The method according to claim 1, wherein a property of the start mark guides a user to properly locate the touch.

7. The method according to claim 1, further comprising receiving a scanned fingerprint, associating the scanned fingerprint with a function, and performing the function in response to receiving the scanned fingerprint.

8. An apparatus comprising at least one processor and at least one memory including computer program code, the at least one memory and the computer program code configured to, with the at least one processor, cause the apparatus to perform:
provide for display of a start mark proximate a fingerprint scanning sensor; and
receive an indication of a touch at the start mark;
wherein the start mark is displayed in a location relative to the fingerprint scanning sensor such that a swipe initiated at the start mark continues across the fingerprint scanning sensor.

9. The apparatus according to claim 8, wherein the apparatus is further caused to provide for display of an instruction, wherein the instruction indicates a desired motion of a finger over the fingerprint scanning sensor.

10. The apparatus according to claim 8, wherein the apparatus is further caused to change at least one property of the start mark in response to receiving the indication of a touch at the start mark.

11. The apparatus according to claim 8, wherein the apparatus is further caused to activate a fingerprint input mode in response to receiving the indication of a touch at the start mark, wherein the fingerprint input mode includes a level of functionality that is different than a level of functionality active prior to activating the fingerprint input mode.

12. The apparatus according to claim 10, wherein causing the apparatus to change at least one property of the start mark in response to the indication of the touch at the start mark includes causing the apparatus to provide an indication of a correct touch pressure in response to receiving an indication of the correct touch pressure at the start mark.

13. The apparatus according to claim 8, wherein a property of the start mark guides a user to properly locate the touch.

14. The apparatus according to claim 8, further comprising causing the apparatus to receive a scanned fingerprint, associate the scanned fingerprint with a function, and perform the function in response to receiving the scanned fingerprint.

15. A computer program product comprising at least one computer-readable storage medium having computer-executable program code instructions stored therein, the computer-executable program code instructions comprising:
program code instructions for providing for display of a start mark proximate a fingerprint scanning sensor;
program code instructions for receiving an indication of a touch at the start mark;
wherein the start mark is displayed in a location relative to the fingerprint scanning sensor such that a swipe initiated at the start mark continues across the fingerprint scanning sensor.

16. The computer program product according to claim 15, further comprising program code instructions for providing for display of an instruction, wherein the instruction indicates a desired motion of a finger over the fingerprint scanning sensor.

17. The computer program product according to claim 15, further comprising program code instructions for changing at least one property of the start mark in response to receiving the indication of a touch at the start mark.

18. The computer program product according to claim 15, further comprising program code instructions for activating a fingerprint input mode in response to receiving an indication of a touch at the start mark, wherein the fingerprint input mode includes a level of functionality that is different than a level of functionality active prior to activating the fingerprint input mode.

19. The computer program product according to claim 17, wherein the program code instructions for changing at least one property of the start mark in response to the indication of the touch at the start mark includes program code instructions for providing an indication of a correct touch pressure in response to receiving an indication of the correct touch pressure at the start mark.

20. The computer program product according to claim 15, further comprising program code instructions for receiving a scanned fingerprint, program code instructions for associating the scanned fingerprint with a function, and program code instructions for performing the function in response to receiving the scanned fingerprint.
